(19) United States
(12) Patent Application Publication
(10) Pub. No.: US 2020/0290226 A1
(43) Pub. Date: Sep. 17, 2020

(54) Shaving Device

(71) Applicant: Neckrazor LLC, Hilton Head Island, SC (US)

(72) Inventor: Frank P. Lucchese, Hilton Head Island, SC (US)

(73) Assignee: Neckrazor LLC, Hilton Head Island, SC (US)

(21) Appl. No.: 16/528,978

(22) Filed: Aug. 1, 2019

Related U.S. Application Data
(60) Provisional application No. 62/827,525, filed on Apr. 1, 2019.
(60) Provisional application No. 62/818,146, filed on Mar. 14, 2019.

(51) Int. Cl. B26B 21/52; B26B 21/40; B26B 21/10

(52) U.S. Cl. CPC B26B 21/525; B26B 21/4056; B26B 21/521; B26B 21/522; B26B 21/10; B26B 21/527

(57) ABSTRACT

The invention is a shaving device that shaves behind the neck and other hard to reach areas of the body. The invention is a device that is comprised of at least one blade mounting assembly that are attached to each other with living hinges along a longitudinal axis, with two handles situated at either end of the set of assemblies along the same axis. When used, a user mounts an individually removable blade cartridge on each mounting assembly.

### PRIORITY CLAIM

This is a non-provisional patent application, that claims the benefit of U.S. Prov. Pat. App. No. 62/827,525 filed on Apr. 1, 2019 and U.S. Prov. Pat. App. No. 62/818,146, filed on Mar. 14, 2019, both of which are hereby incorporated by reference in their entireties for all that they incorporate therein.

### FIELD AND BACKGROUND OF INVENTION

The invention is a shaving device that can be operated by a user to make it possible for the user to reliably and easily shave behind the neck and other hard to reach areas of the user's body.

### BRIEF DESCRIPTION OF THE DRAWINGS

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

FIG. 1: Shows an exemplary configuration of the shaving device from the blade-side perspective.

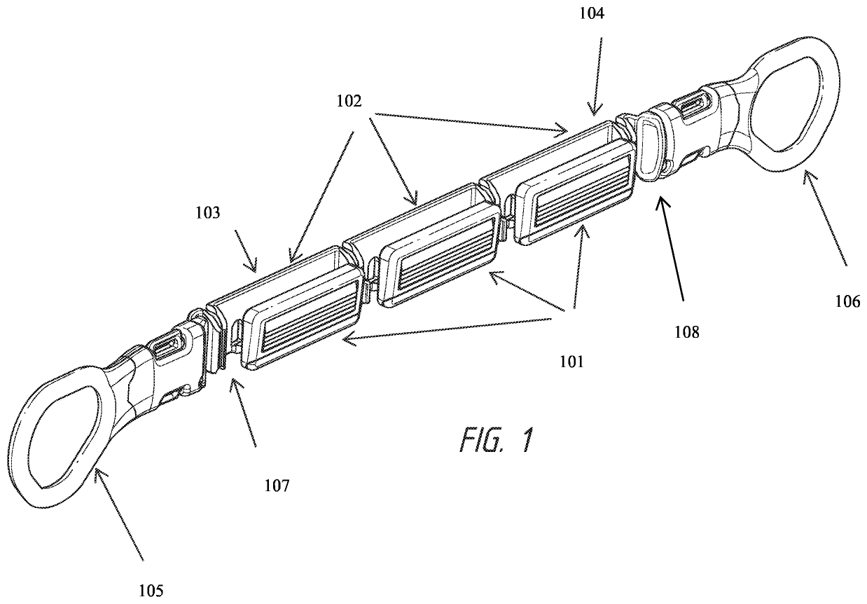

FIG. 2: Shows the exemplary configuration of the shaving device from the back-side perspective.

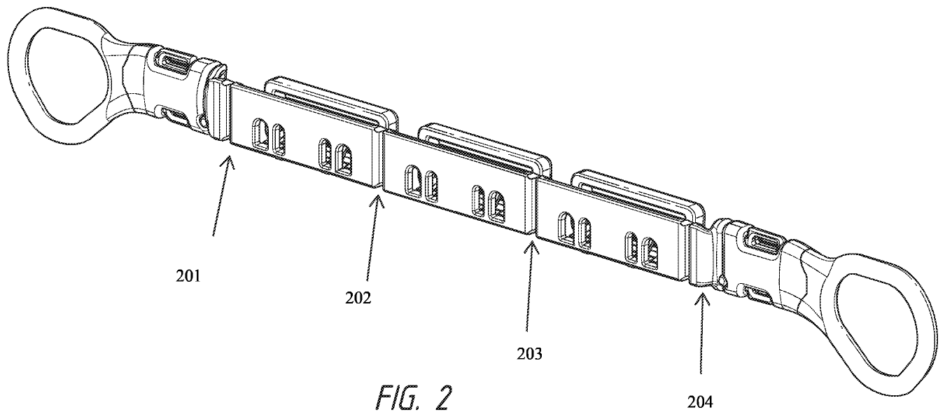

FIG. 3: Shows the exemplary configuration of the shaving device from the blade-side with a front face perspective.

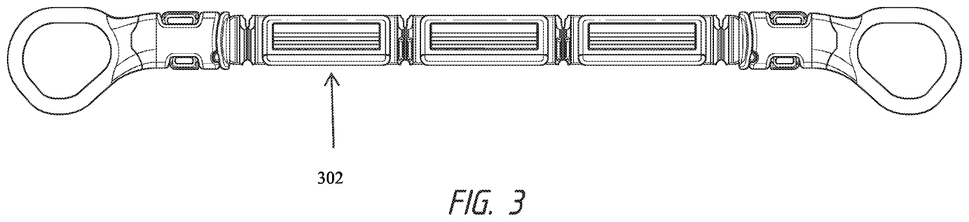

FIG. 4: Shows the exemplary configuration of the shaving device from the top-view perspective.

FIG. 5: Shows the exemplary configuration of the shaving device from the blade-side perspective, with one blade cartridge having the normal axis of its surface at a displaced angle from the normal horizontal plane of the device.

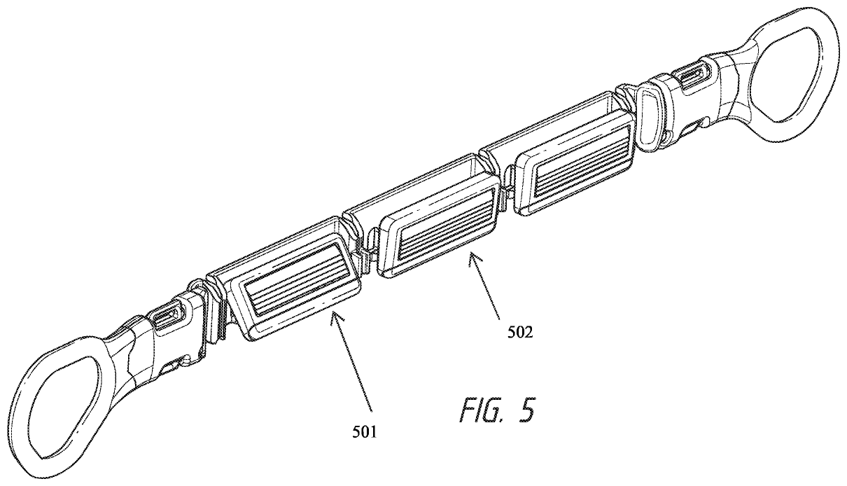

FIG. 6: Shows the exemplary configuration of the shaving device from the blade-side perspective, showing the blade cartridges attached to the blade mounting assembly back.

FIG. 7: Shows the exemplary configuration of the shaving device from the top view perspective, with a close up of the blade cartridges attached by the blade mounting assembly mechanism to the device back.

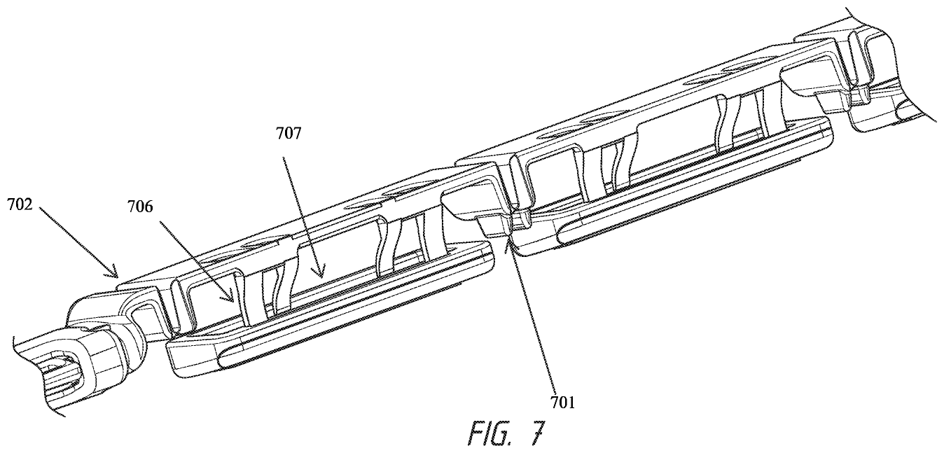

FIG. 8: Shows the exemplary configuration of the shaving device from the top view perspective, with a close up of the blade mounting assembly backs with the blade cartridge attachment mechanisms.

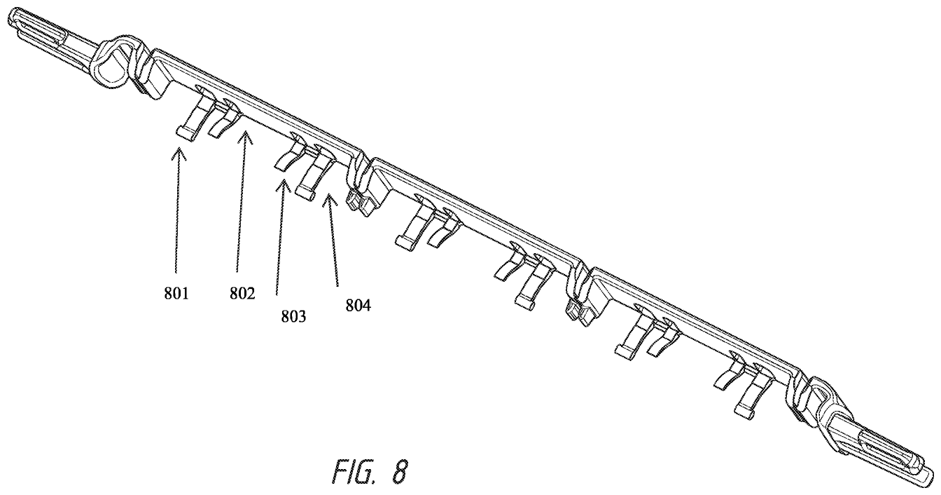

FIG. 9: Shows the exemplary configuration of the shaving device from the side view perspective, with a close up of the blade mounting assembly backs with the blade cartridge attachment mechanisms.

FIG. 10: Shows an exemplary configuration of the handle of the shaving device.

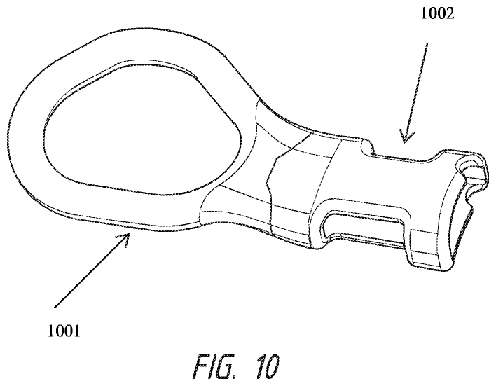

FIG. 11: Shows a close up of the hinge are between two blade mounting assemblies.

FIG. 12: Shows a close up of the blade mounting assembly from the back with the blade cartridge mounted on it using the attachment mechanism.

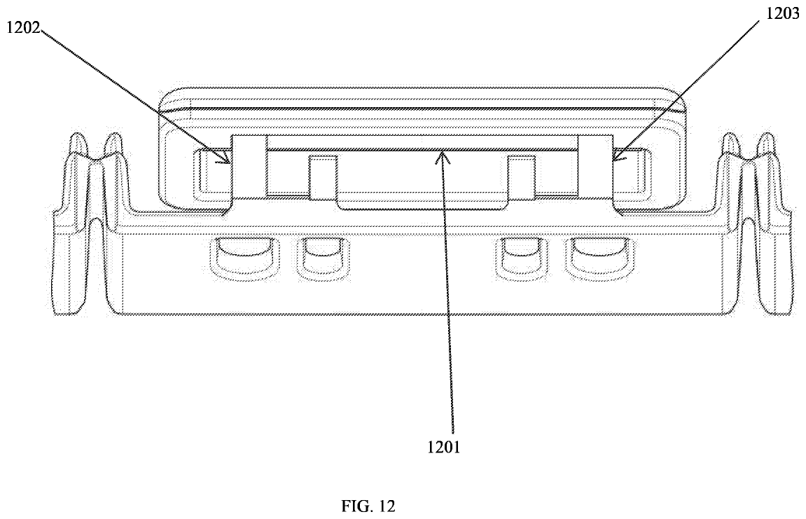

### DETAILED DESCRIPTION OF THE PREFERRED EMBODIMENTS

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The invention is a device that is comprised of at least one blade mounting assembly (102) (602), where a plurality of blade mounting assembly backs (102) (602) are attached to each other along their longitudinal axis by means of a hinges or flexible material (603). In use, at least one shaving blade cartridges (101) are attached by a corresponding at least one mechanical attachment mechanism (601) to the corresponding blade mounting assemblies. The outer two blade moutning assemblies (103, 104) are further attached along the device's longitudinal axis to two corresponding handles (105, 106) with two more flexible hinges that may also be twistable (107, 108). In use, the device is shaped in a curve, or “U”-like shape, with the face of the blade edges on the inside of the “U”, that is, the hinges flex inward in a direction perpendicular to the plane of the blade mounting assemblies. The device hinges (201-204) may be flexible to allow the shape of the device to vary by how the device is held and the shape of the surface being shaved. The blade mounting assemblies (101) are oriented so that the at least one blade cartridges are operably facing the interior of the curve shape (302) formed by the device when in use. The person operating the device can situate the device around the back of their own neck while facing a mirror, yet hold the device using the two handles (105, 106) on either side of their neck. In the preferred embodiment, the distance from the center of the handle component (609, 610) to the edge of the blade cartridges (604, 606) is sufficiently long that the ends of the handles, in use, extend in front of the ear area of the person using the device. In one embodiment, the distance from the center of the handles (105. 106) to the respective hinges attaching the neighboring blade mounting assemblies (107, 108) is between and including 2 to 7 inches. In another embodiment, that distance is approximately 5 inches. In one embodiment, the handles have finger holes in the center. Using a stroking motion perpendicular to the longitudinal axis of the device, the hair on the back of the user's neck area can be shaved by the user.

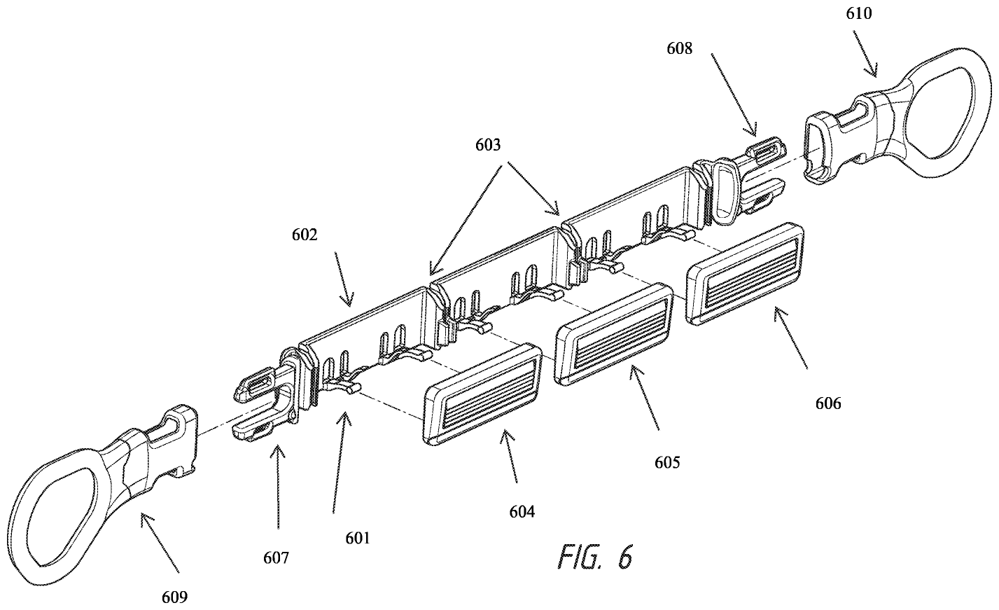

In a further embodiment, as depicted in the figures, the device is comprised of blade mounting assemblies connected by living hinges (202, 203) that provide bend flex and optionally, with torsion flex. In this embodiment, the device is comprised of at least one blade mounting assembly component. (102, 602). This blade mounting assembly components are comprised of an attachment mechanism that permits the blade cartridge to be mechanically attached to the assembly in such a way that that cartridge can be removed and replaced with a fresh blade cartridge. On either end of the set of blade mounting assemblies, ergonomic reusable pull handles (105, 106) are attached. In one embodiment, each razor blade cartridge (101) can be replaced individually on its corresponding blade mounting assembly. As depicted in FIG. 6, each razor blade cartridge (604, 605, 606) may be replaced on its own. In the preferred embodiment, the razor blade cartridges are connected to the blade mounting assemblies via a snap-on pin receiver mounted on the blade mounting assembly (601) that is configured to permit pivoting rotation by the mounted blade cartridge. In one embodiment the dimensions of the face the blade cartridge (101, 302) may be approximately 0.85 inches by approximately 1.17 inches.

In one embodiment, a clip mechanism (601, 706) attached to the mounting assembly (602) may be used to attach the blade cartridge to the blade mounting assembly. In a preferred embodiment, the clip mechanism (601) is integral to the material forming the mounting assembly (602). In the preferred embodiment, the pins that attach the razor blade cartridge to the blade assembly (801, 802, 803, 804) are arranged as two rows of two pins. Two pins on one row (801, 804) have notches or hook shapes to them to hold the cartridge in place. The other row of two pins (802, 803) stabilize the cartridge. The two pins that are hooked or otherwise have a snap mechanism and act as a rotation pin. The rotation pin size and height spacing geometries (which provide pin-arm flex features) provide the cartridge the ability to pivot around the axis defined by the ends of the two rotation pins, which in the preferred embodiment is parallel the longitudinal axis of the blade mounting assembly. The stabilizing pins set the range of the pivot in one direct, while the hook or attachment mechanism on the rotation pins defines the range of the pivot in the other. In this embodiment, the blade cartridge has cartridge slot (1201) on the opposite side from the face of the blade edges. The cartridge slot (1201) may have a height between 0.25 and 0.325 inches in order to achieve the snap function when replacing the razor cartridge, which is done through a push-concept featuring two slide-in pins to engage (802, 803). and two hooked or notched pins that snap into the housing of the cartridge (801, 804). In the preferred embodiment, the distance between the outer pins (1202, 1203) on the same blade mounting assembly is between about 1.25 inch and 1.75 inches. In one embodiment, the blade mounting assemblies permit the blade cartridge (501) to pivot, or rock back and forth vertically, that is, around an axis substantially parallel to the longitudinal axis of the device, but do not permit any appreciable rotational motion that would create a blade cutting edge that is not substantially parallel to the longitudinal axis of the device itself. This motion is separate for each blade cartridge, for example, the angular position of the cartridge (501) is different from that of cartridge (502). In one embodiment, the range of the pivot angle of the blade cartridges, when mounted is less than or about plus or minus 10 degrees from the nominal position, where nominal is when the plane of the blade edges is parallel to the plane of the blade mounting assembly.

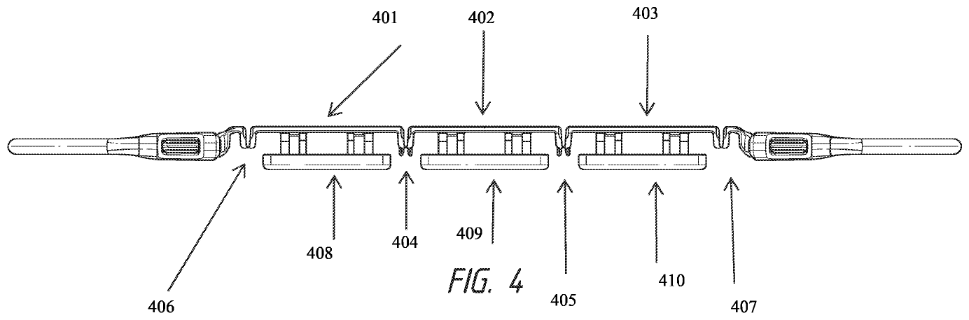

In another embodiment, as depicted in FIG. 4, each blade mounting assembly component in use has a corresponding razor blade cartridges attached to it that may be 1.17 inches wide. In one embodiment, the face of the blades are situated so that the face of the blade edges (408, 409, 410) are at a height of about 0.625 inches off of the interior surface of the blade assemblies (401, 402, 403). The spacing between neighboring blade cartridges (404, 405) when mounted on the mounting assemblies must be sufficiently wide to permit flexibility in the device as it conforms to the dimensions of the surface that is being shaved. As the device flexes inward, the neighboring blade cartridges will move toward each other to the point that they may touch, and limit any further inward flex. If the cartridges are too close, the tightest curve that the device can shave may be too large, or cartridges may pop off the device. If the gap between the blade cartridges is too large, then the device requires more shaving action so that the user doesn't miss shaving parts of the surface. Preferably, each of the blade mounting assemblies are dimensioned in length along the longitudinal axis of the device so that the gap between the neighboring ends of neighboring blade cartridges when mounted on the blade mounting assemblies is between about ¼ inch and 9/16 th of an inch, and preferably about ⅜ of an inch or in some embodiments, half an inch. In one embodiment, the length of the blade mounting assemblies is such that the distance between their interior hinges, for example, (404) and (405) is between and including about ½ inch and about 1 inch, and preferably about ¾ of an inch or in some embodiments, half an inch.

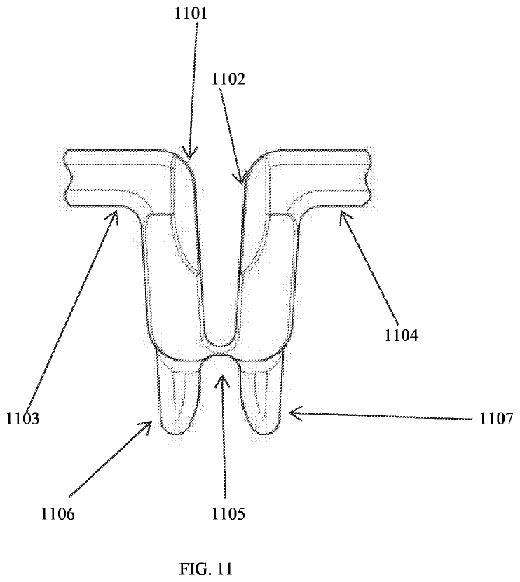

Living hinges, (FIG. 11) or flexible material, connect each of the blade assemblies to each other (202, 203, 701) or the handle assemblies (406, 407, 702) such that in the preferred embodiment, the range of flexibility of the hinge is less than or about plus or minus 30 degrees from the nominal along the longitudinal axis of the device. As shown in the top view of FIG. 11, the hinge sides (1101, 1102) form a sharp angle extending away from the plane of the surface of the blade assemblies (1103, 1104) that come to a connection point that is comprised of a thin, flexible material (1105) that connects between the two neighboring hinge sides of the neighboring blade assembly (1101, 1102). The thin, flexible material between the two assemblies at the connection point (1105) acts as the hinge. The angle of the hinge sides extending away from the plane of the blade assembly to the connection point (1101, 1102) prevents the user from over-stressing the connection point (1105) when flexing outward, away from the blade side of the device, because the two hinge sides (1101, 1102) will meet at the furthest permitted extent of that motion. Similarly, the sides of the hinges have protrusions (1106, 1107) extending past the connection point forming the hinge (1105) that act as stop points in the other direction. If the device is flexed too far inward, toward the blade side of the device, the protruding stop points will meet and stop the motion, thereby alleviating stress on the hinge connection point in that direction (1105).

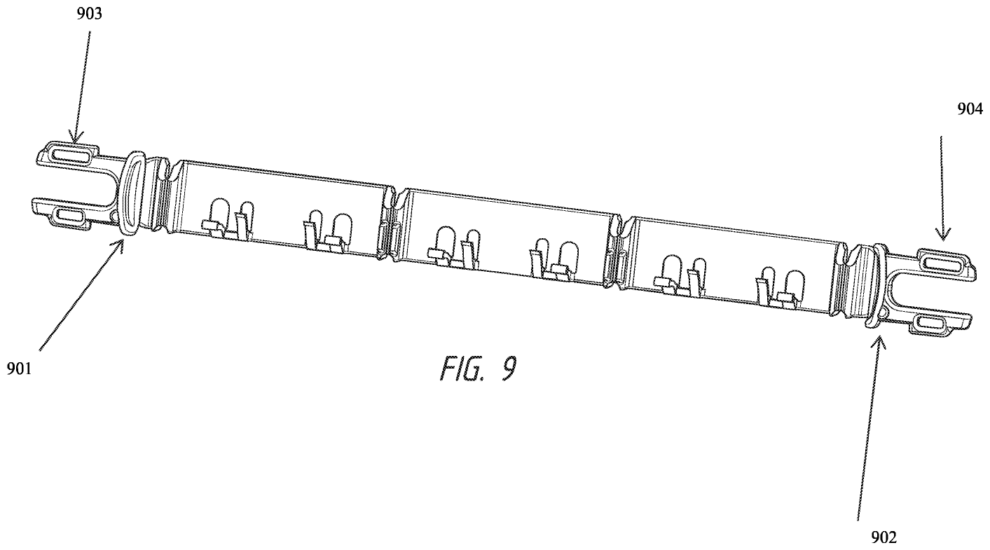

In another embodiment, as depicted in FIG. 9, the set of blade mounting assemblies may be disposable. At either end of the set of blade mounting assemblies, the outer two assemblies have clips (901, 902) to attach reusable handles. In one embodiment, the male side of the clip can slide into and snap into female side comprising of the clip. In this embodiment, the two reusable comfort ring grip handles are comprised of two snap mechanisms (1002), into which either end of the razor mounting strip attach (901, 902). The handle connection (1002) or the blade mounting assembly ends (901, 902) may be equipped with quick release button latches (903, 904). In this embodiment, the entire set of blade assemblies can be replaced by applying pressure to the quick release button latches on each of the grip handles Then, the mounting strip of razor blades (602) may be replaced by snapping the handles onto both ends of a new strip of blade assemblies. In alternative embodiment, the entire blade mounting assembly component is comprised of at least three razor blade cartridges. In this embodiment, the grip handle length may be increased and the area in between the handles and the blade mounting assembly component is round, a single piece of material and comprised of materials to provide for twist or torque around the longitudinal axis of the device. Further, in this embodiment the razor blade cartridges are positioned as close to each other as possible.

In yet another embodiment, the invention may be configured in a more disposable format. In this embodiment, the two handles are connected by one flexible member between them. The flexible member may be comprised of rubber or a flexible plastic. In this embodiment, the invention is comprised razor blades that are integrated into the flexible member directly. In one version of this embodiment, the blades are partially embedded into the material forming the member with spacing between the blades along the longitudinal axis as described above. In another embodiment, the device is comprised of blade cartridges that are attached to the flexible member using an adhesive or by embedding the blade cartridges into the material comprising the flexible member. The gap spacing between the edges of neighboring blade cartridges is as described above. In this version of the invention, the material forming the single flexible member act as the hinges between the blades or cartridges that are embedded or attached to the member. In addition, the handles may be formed as part of the flexible member in one piece.

In yet another embodiment, the device can be further comprised of a sensor that detects the orientation of the device relative to the force of gravity. In the preferred embodiment, the orientation sensor is situated to effectively measure the angle from the longitudinal axis of the device to the direction of gravity. In order that the shaving action produce what would be viewed as a proper cut at the bottom of the back of the scalp of the user, this angle should ideally be 90 degrees, so that the cut line is effectively a horizontal line segment. In this embodiment, the sensor information can feed a microcontroller that determines using program or electronic logic when the device is substantially in a horizontal position. The device handles ends can be further comprised of light emitting devices, typically LEDs, that are operatively connected to the microcontroller and the logic programmed or wired to illuminate the lights when the substantially horizontal position is achieved. In this embodiment, the LEDs may be embedded in the handle assemblies on the blade-side of the device so that they may be viewed by the user while the user uses the device while looking in a mirror. The microcontroller can be any small microprocessor that continuously runs a sensing operation, or a hard-wired logic circuit that performs the same function. In yet another embodiment, the microcontroller is an analog circuit that responds to an analog output of the orientation sensor to control the lights. The microcontroller may be connected through its data input pins to the orientation sensor that detects the direction of gravity. By placing the orientation sensor in the device at a known, predetermined orientation relative to the longitudinal axis of the device, the sensor output effectively delivers to the microcontroller the relative angle of that axis in relation to the direction of gravity, that is, the down direction. The microcontroller can poll the sensor and read the data value constituting the orientation angle of the sensor/device to the down direction. When that value is detected to be within a pre-determined tolerance range, the logic in the program can cause the microcontroller to then activate a “green” LED light that is connected to another output pin on the microcontroller. When that value is detected to be outside that tolerance range, the logic can cause the microcontroller to activate a “red” LED or no LED. The selection between the two outcomes is accomplished with a branching statement in the program that is within the program loop. After activating or deactivating the appropriate LED, the program can return to the top of the loop to fetch the orientation value again and test it with the branching statements again.

What is claimed:

1. A shaving device comprised of: a set of at least two blade mounting assemblies each assembly having a first end and a second end, where the first end of a first assembly comprising the set is connected to the second end of a second assembly comprising the set along their longitudinal axis by means of a hinge, said set of at least two blade mounting assemblies being further comprised of a first and second exterior ends, where the first exterior end is connected along its longitudinal axis to a first handle and the second exterior end is connected along its longitudinal axis to a second handle, said blade mounting assemblies further comprised of an attachment mechanism for attaching, when in use, a corresponding at least two razor blade cartridges.

2. The shaving device of claim 1 where the set of at least two blade mounting assemblies is comprised of at least a first, second and third blade mounting assemblies, and the distance between a first hinge connecting the first and second assemblies and a second hinge connecting the second and third assemblies is between and including about ½ inch and about 1 inch.

3. The shaving device of claim 2 where the distance is about ¾ of an inch.

4. The shaving device of claim 2 where the distance is about half an inch.

5. The shaving device of claim 1 where the hinge is comprised of a flexible material and flexes in a direction perpendicular to the plane of the blade mounting assemblies.

6. The shaving device of claim 5 where the range of flexibility of the hinge is less than or about plus or minus 30 degrees from the nominal line along the longitudinal axis of the device.

7. The shaving device of claim 5 where the hinge is comprised of a first and second hinge sides that are integral to a first and second neighboring blade mounting assembly comprising the set, said first and second hinge sides shaped to extend at an angle away from the plane of the first and second blade mounting assemblies and toward the flexible connecting material comprising the hinge in a configuration that limits the movement of the hinge in an outward direction as a result of the two hinge sides meeting each other.

8. The shaving device of claim 5 where the first and second hinge sides are comprised of a corresponding first and second protrusions extending past from the flexible connecting material comprising the hinge in a configuration that limits the movement of the hinge in an inward direction as a result of the two protrusions meeting each other.

9. The shaving device of claim 1 where the connection between the first and second exterior ends and the first and second handles is comprised of a flexible material that permits a twisting motion around the longitudinal axis of the device.

10. The shaving device of claim 1 where the distance from the center of the first and second handles to the first and second exterior ends of the set of blade mounting assemblies is between and including 2 to 7 inches.

11. The shaving device of claim 10 where the distance is approximately 5 inches.

12. The shaving device of claim 1 where the attachment mechanism is comprised of at least two snap-on pins that stand off the plane of the blade assembly that are configured so that in use, the mounted blade cartridge can pivot around an axis that is defined by the two exterior end points of the two snap-on pins.

13. The shaving device of claim 12 where the pins forming the attachment mechanism are integral to the material forming the blade mounting assembly.

14. The shaving device of claim 12 further comprising two stabilizing pins that stand off the plane of the blade assembly, arranged so that on each blade mounting assembly, there are two rows of pins, with the snap-on pins in the first row and the stabilizing pins in the second row.

15. The shaving device of claim 12 where the distance between the snap-on pins on the same blade mounting assembly is between about 1.25 inch and 1.75 inches.

16. The shaving device of claim 12 where the blade mounting assembly and its snap-on pins are configured to limit the range of the pivot angle of the blade cartridges, when in use, to less than or about plus or minus 10 degrees from the nominal position that is the plane of the blade edges being parallel to the plane of the blade mounting assembly.

17. The shaving device of claim 1 further comprising a corresponding at least two blade cartridges mounted on the at least two blade mounting assemblies.

18. The shaving device of claim 17 where the width of the blade cartridges along the longitudinal axis of the blade assembly is about 1.17 inches wide.

19. The shaving device of claim 17 where the blade cartridges have a face of blade edges that is situated so that the blade edges are at a height of about 0.625 inches off of the of the interior surface blade assemblies.

20. The shaving device of claim 17 where the blade cartridges are situated so that the gap between the neighboring ends of neighboring blade cartridges is between about ¼ inch and about 9/16 inch.

21. The shaving device of claim 20 where the blade cartridges are situated so that the gap between the ends of neighboring blade cartridges is about ⅜ of an inch.

22. The shaving device of claim 20 where the blade cartridges are situated so that the gap between the ends of neighboring blade cartridges is about half an inch.

23. The shaving device of claim 17 where the dimensions of the face of the blade cartridges is approximately 0.85 inches by 1.17 inches.

24. The shaving device of claim 17 where the blade cartridges are comprised of an interior side the opposite side from the blade edge face, said interior side having at least one slot where the at least one slot has a height between 0.25 and 0.325 inches in order to achieve the snap function when replacing the razor cartridge.

25. The shaving device of claim 1 where the first and second handles are connected to the set of blade assemblies by means of a first and second corresponding reusable clip mechanism.

26. The shaving device of claim 25 where the clip mechanism is comprised of a male slide component that in use slides into a female receiving component and snaps into place.

27. The shaving device of claim 1 further comprising:
An orientation sensor;
At least one light emitting device;
A microcontroller operatively connected to the orientation sensor and the light emitting device.

28. A shaving device comprised of:
a member comprised of a material in a predetermined shape with an exterior and interior side and a first and second end,
at least one razor blades attached to the member on the interior side and along the longitudinal axis of the member; and
a first and second handles attached to the corresponding first and second ends of the member.

29. The shaving device of claim 28 where the attached razor blades are partially embedded into the material.

30. The shaving device of claim 28 where the attached razor blades comprise blade cartridges that are partially embedded into the material.

31. The shaving device of claim 28 where the attached razor blades comprise blade cartridges that are glued to the interior side of the member using an adhesive.

32. The shaving device of claim 28 where the attached razor blades comprise blade cartridges that are mechanically attached to the material.

33. The shaving device of claim 28 where the first and second handles are attached to the member by a corresponding first and second attachment clips.

34. The shaving device of claim 28 where the first and second handles are comprised of and integrated with the material comprising the member.

35. The shaving device of claim 28 where the predetermined shape is a “U” like curve with the blades on the interior of the “U”.

36. The shaving device of claim 28 where the predetermined shape is initially substantially linear and the material comprising the member is flexible such that in use, the member may be moved into a “U” like shape with the blade side on the interior of the “U”.
